(19) United States
(12) Patent Application Publication
(10) Pub. No.: US 2017/0231859 A1
(43) Pub. Date: Aug. 17, 2017

(54) SCALP SCRATCHING DEVICE

(71) Applicants: Thelma Beans, Forrest City, AR (US); J'Donesha Williams, Forrest City, AR (US)

(72) Inventors: Thelma Beans, Forrest City, AR (US); J'Donesha Williams, Forrest City, AR (US)

(21) Appl. No.: 15/044,284

(22) Filed: Feb. 16, 2016

(51) Int. Cl. A61H 7/00

(52) U.S. Cl. CPC A61H 7/003

(57) ABSTRACT

A pen like device for scalp scratching that includes: a retractable top; a clip attached extending over one side of the retractable top; a mid section; a distal end, where the distal end includes an opening; and a plurality of tentacles adapted to extend and retract through the opening.

### BACKGROUND OF THE INVENTION

Field of Invention

The present invention relates to scalp scratching device that provides a convenient and easy means for a user to scratch an itchy scalp.

Description of Related Art

It is quite common for many people to braid their hair as a hairstyle. One common format for hair braiding is a style that includes cornrows that are braided across the scalp of an individual. Typically these braids must be tight in order to maintain the hairstyle. One drawback to this hairstyle is that the rows of braids can typically become itchy over a period of time. The scalp, depending on the style of braiding, may be difficult to reach due to the multiple braids that are used for the hairstyle. As a result, it is difficult to scratch the itchy scalp between the braided hairs without compromising the hairstyle. It would therefore be advantageous to have a small simple device that can be used to address this particular issue with respect to hairstyling.

### SUMMARY OF THE INVENTION

The present invention relates to a pen like device for scalp scratching that includes: a retractable top; a clip attached extending over one side of the retractable top; a mid section; a distal end, where the distal end includes an opening; and a plurality of tentacles adapted to extend and retract through the opening.

### BRIEF DESCRIPTION OF DRAWINGS

FIG. 1 depicts a perspective view of a scalp scratching device according to the present invention.

### DETAILED DESCRIPTION

The present invention relates to a scalp-scratching device that includes a pen-like structure with an opening at a distal end and a retractable button at the top end. The device is formed in the shape of a pen and includes an opening that allows the extension and retraction of a plurality of tentacles that extend out of the opening and retract into the opening when not in use. Preferably, the scalp-scratching device includes a clip extending from the top retractable button. The clip allows a user to easily clip the scalp scratcher into their vest pocket of the shirt or if in a jacket, therefore easily having access to the device.

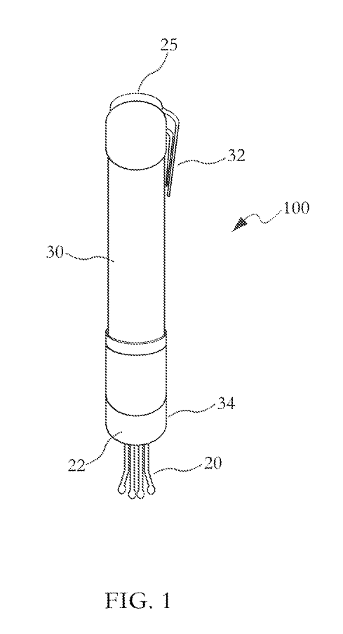

In reference to FIG. 1, a perspective view of a Scalp Scratcher 100 is depicted. The Scalp Scratcher 100 includes a retractable top 25 that is depressed by a user to extend tentacles 20 out of the opposite end of the Scratcher 100. The tentacles 20 extend out of a distal end 34 that includes an opening 22. The opening 22 allows for the movement of the tentacles 20 from the inner portion of the Scratcher 100 to an exposed position as shown in FIG. 1 to allow a user to use this grouping of tentacles 20 to scratch the scalp below a braided area. Although preferably used for a braided scalp, the tentacles of course may be used for general scratching of an individual's scalp and may assist any person who may have other difficulties in scratching their scalp such as people that insert hair extensions and other hair implementations in their existing hair over the scalp.

The Scalp Scratcher 100 includes a mid section 30 that extends vertically as shown in

FIG. 1 between the distal end 34 and the retractable top 25. As stated, the user depresses the retractable top 25 to extend the tentacles 20 out of opening 22. Preferable this scratcher 100 is configured in a pen-like shape and includes a clip 32 to allow for the placement of the scratcher 100 into a user's chest or vest pocket. The instant invention has been shown and described in what it considers to be the most practical and preferred embodiments. It is recognized, however, that departures may be made there from within the scope of the invention and that obvious modifications will occur to a person skilled in the art.

What is claimed is:

1. A pen like device for scalp scratching comprising:
a. a retractable top;
b. a clip attached extending over one side of the retractable top;
c. a mid section;
d. a distal end, where the distal end includes an opening; and
e. a plurality of tentacles adapted to extend and retract through the opening.

2. A method of scalp scratching using a pen like device comprising the steps of:
a. depressing a retractable top of the pen like device, where step of depressing releases a plurality of tentacles from a distal end of the pen like device; and
b. manipulating the tentacles onto particular areas of a scalp; and
c. depressing the retractable top, where this step of depressing retracts the tentacles back into the pen like device.
